(19) United States
(12) Patent Application Publication
(10) Pub. No.: US 2013/0163567 A1
(43) Pub. Date: Jun. 27, 2013

(54) Transmission System and Transmission Method for the Wireless Transmission of Signals in an Automation Installation, and Automation Installation having such a Transmission System

(71) Applicant: Gunther May, Karlstadt (DE)

(72) Inventor: Gunther May, Karlstadt (DE)

(21) Appl. No.: 13/634,546

(22) PCT Filed: Feb. 19, 2011
(86) PCT No.: PCT/EP2011/000803

§ 371 Date: Nov. 26, 2012

(30) Foreign Application Priority Data
Mar. 23, 2010 (DE) 10 2010 012 330.7

(51) Int. Cl. H04W 72/04

(52) U.S. Cl. CPC H04W 72/0466
USPC 370/335; 370/329

(57) ABSTRACT

A transmission system and a transmission method for the wireless transmission of signals in an automation installation and also an automation installation having such a transmission system is disclosed. The transmission system is used for the wireless transmission of signals between a plurality of elements of an automation installation and comprises a plurality of network nodes, to which a respective element from the plurality of elements of the automation installation is connected. In this context, each network node has an associated separate, continuously useable logical channel which can be used to transmit signals wirelessly.

The invention relates to a transmission system and a transmission method for the wireless transmission of signals in an automation installation, and an automation installation having such a transmission system.

In automation systems, transmission methods are conventionally used which are based on wired technology. In this technology, a fieldbus, for example, connects field devices, such as measurement elements or sensors and setting elements or actuators in an automation installation for communication with a control device. In most cases, a multiplicity of sensors and actuators are present and the sensors and actuators transmit all signals via the same fieldbus, i.e. the same line. To avoid collisions between the signals, it must be established who (identifier) transmits what (measurement value, command) and when (initiative). Standardized protocols are available for this purpose, which are standardized worldwide for fieldbuses in the IEC 61158 standard (“Digital data communication for measurement and control—Fieldbus for use in industrial control systems”).

Currently, wireless transmission systems are also increasingly offered by some manufacturers in order to increase the flexibility and practicability of automation systems and/or reduce costs. Along with a support for a large number of nodes, the guarantee of immunity to interference with an acceptable range, the provision of high data rates, low costs, a hot-plug capability and a low antenna cost, the characteristic of real-time capability (synchronicity/simultaneity, delay, jitter) is also required.

Known solutions for the wireless transmission of signals in automation systems, for example based on Wireless LAN (IEEE 802.11), normally use various different time division multiple access (TDMA) methods as a multiplexing technique for the transmission of the signals. In the time division multiple access (TDMA) method, either a “time slice” scheme, which is shown in FIG. 4., or an arbitration method is used. Other systems are based, for example, on Bluetooth (802.15.1); although Frequency Hopping (FH) is used here for media access, the nodes of a network similarly transmit sequentially here, so that time division multiple access is involved here also. Occasionally, TDMA is also used in combination with frequency division multiplexing, for example if a plurality of frequency channels can be used simultaneously. The TDMA methods are then used in turn on the individual channels.

In the time slice scheme, as shown in FIG. 4, signals are transmitted in each case with fixed cycle times T. One (or, where appropriate, several) of a plurality of predefined fixed time slices T1, T2, etc., in which the network node can transmit signals, is allocated here to each of numerous network nodes 1, 2, etc. in an automation system within each of the fixed cycle times T. This means that, in the example in FIG. 4, only the network node 1 can initially transmit signals in the time slice T1, whereafter only the network node 2 can transmit signals in the time slice T2, and then only the network node 3 can transmit signals in the time slice T3, and then only the network node 4 can transmit signals in the time slice T4. If, at a time t1, which lies in the time slice T2 of the network node 2, which is later in time than the time slice T1 assigned to the network node 1 in a cycle time T, an event represented by a jagged arrow then takes place, the network node 1 again has the possibility to transmit the signal associated with the event only at the beginning of the next cycle time T. More precisely expressed, the network node requires a response time t2=T−t1, until it can transmit the event.

Therefore, in the time slice scheme, although signal collisions are reliably avoided when a transmission channel accessible by the network nodes is accessed, comparatively high response times arise in the time slice scheme.

In the arbitration method, the individual network nodes decide locally on the access to the transmission channel. Signal collisions can frequently be avoided, e.g. through allocation of differently high priorities when the transmission channel is accessed, but not in all cases. However, very high response times can also arise for individual events, e.g. if a lower priority has been allocated to them compared with other events and they are thereby transmitted with a time delay, or a collision must be resolved.

As a result, both the time slice scheme and the arbitration method have a low real-time capability. For this reason, both the time slice scheme and the arbitration method cannot even be used in many automation technology applications.

The object of the invention is therefore to provide a transmission system and a transmission method for the wireless transmission of signals in an automation installation, and also an automation installation having such a transmission system, in which the response times of the wireless transmission can be significantly improved, with a simultaneously low error rate, and the real-time capability in the automation installation is therefore guaranteed.

The object is achieved by a transmission system as claimed in patent claim 1, which is used for the wireless transmission of signals between a plurality of elements of an automation installation and comprises a plurality of network nodes to which one element of the plurality of elements of the automation installation is in each case connected. A separate, continuously usable logical channel is allocated here to each network node, via which signals can be transmitted wirelessly.

Advantageous further designs of the transmission system are indicated in the dependent patent claims.

The separate, continuously usable logical channels can preferably be made available via a code division multiple access method.

For example, the separate, continuously usable logical channels can be made available by allocating various convolutional sequences to the network nodes in (DSSS (Direct Sequence Spreading Spectrum)) CDMA (Code Division Multiple Access).

The separate, continuously usable logical channels can also be made available by making available various hop sequences in (FH (Frequency Hopping)) CDMA.

It is also possible for the separate, continuously usable logical channels to be made available as a subset of individual carriers by using OFDM (Orthogonal Frequency Division Multiplex) methods.

It is advantageous if the transmission system also has a data rate setting device to set the available data rate of the individual logical channels according to current demand.

In addition, it is advantageous if the transmission system also has an error correction device to carry out a forward error protection method to reduce transmission errors.

The object is also achieved by an automation installation as claimed in patent claim 8, which is used to automate a technical process and comprises a control device to control a performance of the technical process by means of at least one drive device and a transmission system as claimed in one of the preceding claims.

The object is also achieved by a transmission method as claimed in patent claim 9. The transmission method is used for the wireless transmission of signals between a plurality of elements of an automation installation and comprises the step of the wireless transmission of the signals by means of a plurality of network nodes to which one element of the plurality of elements of the automation installation is connected, wherein a separate, continuously usable logical channel is allocated to each network node, via which signals are transmitted wirelessly.

With the transmission system described above and the transmission method for the wireless transmission of signals in automation installations and an automation installation having such a transmission system, a significant improvement in the response times in the transmission of the signals and therefore the real-time capability compared with previous wireless transmission methods in automation systems can be achieved. A genuine simultaneity in the transmission becomes possible. In addition, the error rate can be kept very low by means of forward error protection methods.

The invention is explained in detail below with reference to the attached drawings and on the basis of example embodiments, wherein:

FIG. 1 shows a block diagram of an automation installation with a transmission system for the wireless transmission of signals according to a first example embodiment of the present invention;

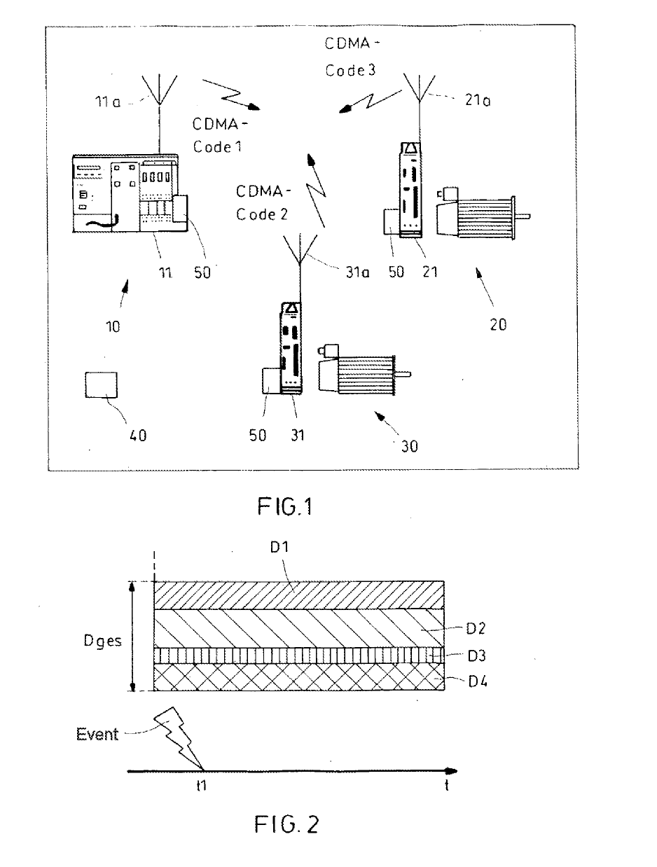

FIG. 2 shows a diagram which illustrates the response time in a transmission system according to the first example embodiment of the present invention;

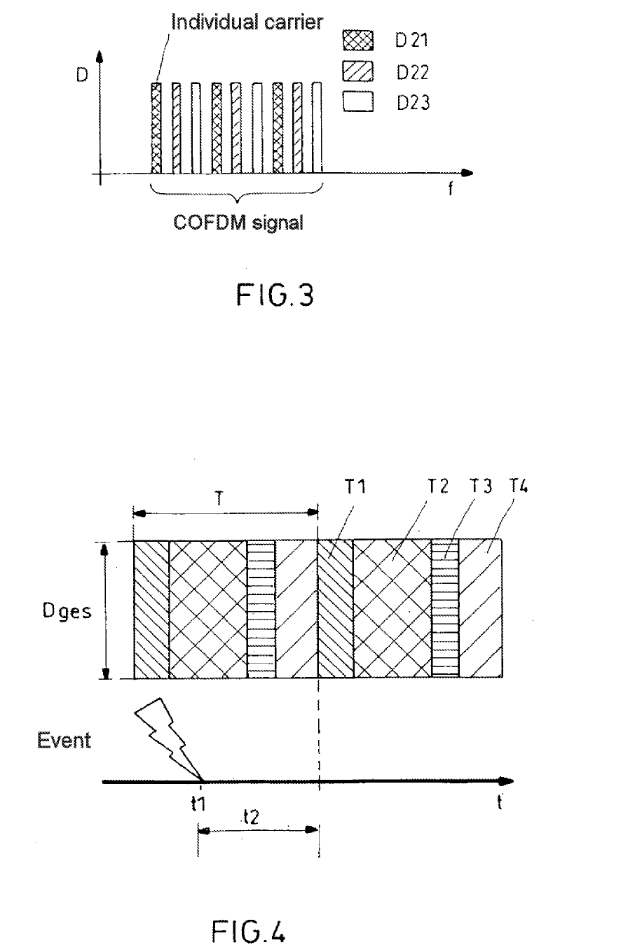

FIG. 3 shows a diagram which illustrates the principle of the performance of a wireless transmission of signals according to a second example embodiment of the present invention; and

FIG. 4 shows a diagram which indicates the response time in an automation installation according to the prior art.

### FIRST EXAMPLE EMBODIMENT

FIG. 1 shows the basic structure of an automation installation 1 with a control device 10, a first and second drive device 20, 30, transmission devices or network nodes 11, 21, 31, antennas 11a, 21a, 31a, a data rate setting device 40, and an error correction device 50. The transmission devices or network nodes 11, 21, 31 are shown schematically in FIG. 1 by means of a module. However, this representational form does not exclude the modules shown in FIG. 1 also from performing various other functions for controlling, for example, motors, etc., in addition to the function for communication by means of the transmission devices or network nodes, 11, 21, 31.

An automation installation 1 is an installation in which technical processes, for example the manufacture of a product, are performed in automated fashion. The automation installation 1 may, for example, be a CNC lathe, a vehicle production line, an installation for producing chemical substances, etc.

The first and second drive devices 20, 30 are also to be understood to include not only, for example, an electric motor, but also elements of the automation installation 1, such as sensors for recording measurement signals, such as, for example, the setting of parts of the drive device or the temperature of parts of the automation installation, etc., or setting elements for defining specific settings of the drive devices 20, 30, etc. In addition, the control device 10 is also an element of the automation installation 1.

The data rate setting device 40 is used to set the available data rate, as described in more detail below. This device is mostly, but not necessarily, integrated into the control device 10. The error correction device 50 is used to reduce transmission errors in the wireless transmission of signals. This correction device is implemented in all network nodes.

In FIG. 1, the control device 10 has a transmission device 11 for the wireless transmission of signals to the drive devices 20, 30. To do this, the drive device 20 has a transmission device 21 for the wireless transmission of signals to the control device 10 and/or the drive device 30, or its transmission devices 11, 31. The drive device 30 has a transmission device 31 for the wireless transmission of signals to the control device 10 and/or the drive device 20 or its transmission devices 11, 21. This means that the signals transmitted by the transmission device 11 of the control device 10 can be received by the transmission devices 21, 31 of the drive devices 20, 30, and the signals transmitted by the transmission devices 21, 31 of the drive devices 20, 30 can be received by the transmission device 11 of the control device 10 and the transmission devices of the respective other drive device. For the transmission, the transmission devices 11, 21, 31 in each case comprise an antenna 11a, 21a, 31a which can be disposed, for example as in FIG. 1, on top of the respective transmission devices 11, 21, 31, or remotely and connected via connection cables.

The transmission devices 11, 21, 31 form a transmission system for the wireless transmission of signals in the automation installation. The signals are, for example, data signals, so that the expression “transmission of data” is also used below partially instead of the expression “transmission of signals”.

More precisely, the transmission devices 11, 21, 31 are network nodes of the transmission system and transmit the signals with the aid of the code division multiple access (CDMA) method in which the simultaneous transmission of different signal streams in a joint frequency range is enabled. Here, the jointly used frequency range occupies a larger bandwidth than that of the useful datastream of the signal of a network node. To do this, a narrowband signal must be converted into a signal with a larger bandwidth than is necessary for the information transmission, which is referred to as frequency spreading. Specific spreading codes are used for frequency spreading and for distinction of the different datastreams transmitted in parallel in the jointly used frequency band. The spreading codes or spreading code sequences additionally have specific properties such as orthogonality (independence of the components of composite signals from one another) and are based in specific applications on pseudorandomness (something which appears random, but is in reality calculable). The original useful datastreams can thereby be obtained separately from one another on the side of the receiver through correlation with the spreading code sequence. In contrast to conventional multiplexing methods such as frequency division multiplexing and the time division multiplexing described above, a heterodyning in both the frequency range and the time range of the individual datastreams takes place in code division multiplexing. Thus, in this example embodiment, the transmission device 11 transmits a CDMA signal with the code 1, the transmission device 21 transmits a CDMA signal with the code 2 and the transmission device 21 transmits a CDMA signal with the code 3, as shown in FIG. 1.

Expressed more precisely, each of the transmission devices 11, 21, 31 forms a network node, to which a separate, continuously usable logical channel is allocated. This is shown in FIG. 2, in which only a part D1 of the total available data rate Dges is allocated to the transmission device 11 or a first network node 11, but the first network node 11 can use this part D1 over the entire time axis, i.e. continuously. The parts D2, D3, and D4 of the total available data rate Dges are allocated to the other transmission devices 21, 31 or the second and third network nodes 21, 31 and a fourth network node not shown in FIG. 1. This means that the part D1 corresponds to the respective separate, continuously usable logical channel of the network node 11, etc.

Each network node 11, 21, 31 transmits or transfers signals with a different CDMA code (1, 2, 3) from that of the respective other network nodes. The signals of all other network nodes are thereby received by one network node, and a logical ring structure can also be implemented.

If an event occurs in network node 21 at time t1 in such a configuration in FIG. 2, the network node 21 can transmit the event immediately in a wireless manner to the control device 10. In theory, there are no restrictions here on the response time, even if certain response time restrictions exist in practice. However, these are substantially less than in the hitherto known transmission systems for the wireless transmission of signals in automation installations.

On the basis of this configuration of the transmission devices or network nodes 11, 21, 31, the cycle time of the transmission of signals can be defined independently from the media access or access to the network nodes 11, 21, 31.

According to a particular design variant of this example embodiment, the separate, continuously usable logical channels D1, D2, D3 of the network nodes 11, 21, 31 can be made available to the network nodes 11, 21, 31 in the DSSS-CDMA method (DSSS=Direct Sequence Spreading Spectrum) through the allocation of different CDMA codes, also referred to as convolutional sequences. The DSSS-CDMA is an asynchronous CDMA method in which the output signal is spread by means of a predefined bit sequence, also referred to as a spreading code or chipping sequence. In this method, the useful data are linked in a direct sequence via Exclusive-Or (XOR) with a spreading code and are subsequently modulated onto a carrier. In DSSS, the band spreading is in the foreground in contrast to the code division multiplexing method and multiple use. Due to the spreading, a larger bandwidth is required for the transmission. The energy density in the spectrum is simultaneously also reduced, so that other signals are subjected to less interference. The useful datastream can be reconstructed once more in the receiver only by using the correct chipping sequence.

According to a further particular design variant of this example embodiment, the separate, continuously usable logical channels D1, D2, D3 of the network nodes 11, 21, 31 can be made available to the network nodes 11, 21, 31 in the frequency hopping method (FHSS) or FH-CDMA method (FH=Frequency Hopping) through the allocation of different hop sequences. In the frequency hopping method, the information to be transmitted is distributed consecutively onto many separate channels. Only one frequency channel is ever used here at one specific time. Although each channel has a smaller bandwidth, this produces a larger bandwidth for the overall signal. The receiver must hop to the same channels synchronously with the transmitter. The difference between FHSS and conventional frequency division multiplexing lies in the fact that the channel occupancy is effected sequentially in the frequency hopping method, whereas the signal components are present simultaneously in the individual channels in conventional frequency division multiplexing.

This means that, in the transmission of signals, very short response times to events are possible in all design variants of this example embodiment, so that the real-time capability in the transmission of signals is significantly improved. In addition, a high immunity to interference of the signal transmission exists due to the broadband properties of the CDMA method. In addition, a high number of users is possible, among whom the data rates can furthermore be flexibly distributed.

It is advantageous if an available data rate of the individual logical channels D1, D2, D3 allocated in each case to the network nodes 11, 21, 31 can be varied according to the current transmission requirement of the individual network nodes 11, 21, 31. To do this, the transmission system 11, 21, 31 can have the data rate setting device 40 for setting the available data rate of the individual logical channels D1, D2, D3 according to current demand. As a result, the transmission system becomes more flexible in terms of changing transmission requirements of the individual network nodes 11, 21, 31, so that, in addition to the response time to specific events on the network nodes 11, 21, 31, the transmission time for such events can also be kept as short as possible. This results in an efficiency gain and furthermore the real-time capability of the transmission system can thereby be further increased.

A forward error protection method can be used to reduce transmission errors in the transmission system of the preceding example embodiments. To do this, the transmission system can have the error correction device 50, which carries out the forward error protection method. Here, the error correction device 50 causes the individual network nodes 11, 21, 31 to code the data to be transmitted in a redundant manner, so that the network node receiving the data can recognize and correct transmission errors without an enquiry to the transmitting network node. As a result, in the case of a damaged signal, no new signal request is required in the transmitter.

### SECOND EXAMPLE EMBODIMENT

The arrangement of the automation installations 1 and the transmission system according to this example embodiment is the same as the arrangement shown in FIG. 1 of the preceding example embodiment and described in this connection.

However, in contrast to the preceding example embodiment, the separate, continuously usable logical channels D1, D2, D3 of the network nodes 11, 21, 31 are not provided in the present example embodiment via CDMA, but as a subset of individual carriers through the use of the OFDM method (OFDM=Orthogonal Frequency Division Multiplex). The OFDM method is a multiplexing method which uses a plurality of orthogonal carrier signals for digital data transmission, as shown in FIG. 3. Here, the useful information to be transmitted with a higher data rate is initially divided among a plurality of partial datastreams D21, D22, D23 with a lower data rate, these partial datastreams D21, D22, D23 are modulated each in turn with a conventional modulation method, for example quadrature amplitude modulation, etc., with a smaller bandwidth, and the individual carrier signals are then added. So that the individual carrier signals are distinguishable in the receiver for modulation, functional areas allocated to the carrier signals should be orthogonal in relation to one another. As a result, the carrier signals interfere with one another as little as possible. The COFDM method (COFDM=Coded Orthogonal Frequency Division Multiplex) (multi-carrier method) is also particularly advantageous in this connection.

Here also, a logical ring structure can again be implemented, in a manner similar to the CDMA method used in the first example embodiment. The OFDM method results in a frequency interleaving effect, which increases the immunity to interference of the transmission of signals. However, the number of carriers and the transmission system cycle time interfere with one another.

The representation of the division of the available overall data rate among the datastreams D1 to D4 in FIG. 2 is therefore also valid for this example embodiment. This means that, in the transmission of signals, very short response times to events are also possible in this example embodiment, so that the real-time capability in the transmission of signals is significantly improved.

### (General)

All of the configurations of the transmission system, the transmission method and the automation installation described above can be used individually or in all possible combinations. The following modifications in particular are conceivable here.

In order to achieve an even higher correction capability of the forward error protection method carried out by the error correction device 50, a time interleaving can be applied which enables a more even distribution of transmission errors. However, the interleaving depth and the achievable minimum cycle time of the transmission system interfere with one another here.

Even if only one control device 10 is previously described for the automation installation 1, the automation installation 1 may also have more than one control device 10, wherein, for example, one of the control devices 10 is in each case superordinated to the others. In addition, any given number of drive devices 20, 30 or elements of the automation installation 1 and therefore the network nodes 21, 31 of the transmission system 1 may be used. In particular, the number may also be more than 100.

In addition to the transmission system 11, 21, 31 for the wireless transmission of signals, the automation installation 1 may also have and use a conventional wired transmission system for the transmission of signals between specific elements 10, 20, 30 of the automation installation 1. In this way, both systems (wireless, wired) can be used in each case in the places of the automation installation 1 where they offer the greatest advantage compared with the other system.

In the wireless transmission, frequencies in the frequency spectrum from UHF to SHF, i.e. in the range from approx. 100 MHz to 10 GHz, can be used. At these frequencies, an advantageous relationship between antenna size and transmission behavior exists.

In the second example embodiment, a use of multiple antenna (MIMO) techniques is furthermore conceivable in order to effect an interference reduction.

### Reference Symbol List

1 Automation installation
10 Control device
11 Transmission device or first network node
11a Antenna
20 Drive device
21 Transmission device or second network node
21a Antenna
30 Drive device
31 Transmission device or third network node
31a Antenna
40 Data rate setting device
50 Error correction device
D1 to D4 Available data rate on a logical channel, or logical channel
D21 to D23 Individual carrier
Dges Available total data rate of the transmission system
t1 Time of an event
t2 Response time
T Cycle time
T1 to T4 Time slice

1. A transmission system for the wireless transmission of signals between a plurality of elements of an automation installation, comprising:
a plurality of network nodes to which one element of the plurality of elements of the automation installation is in each case connected,
wherein a separate, continuously usable logical channel, via which signals are configured to be transmitted wirelessly, is allocated to each network node.

2. The transmission system as claimed in claim 1, wherein the separate, continuously usable logical channels are made available via a code division multiple access method.

3. The transmission system as claimed in claim 1, wherein the separate, continuously usable logical channels are made available by allocating different convolutional sequences to the network nodes in (DSSS)-CDMA.

4. The transmission system as claimed in claim 1, wherein the separate, continuously usable logical channels are made available by making different hop sequences available in (FH)-CDMA.

5. The transmission system as claimed in claim 1, wherein the separate, continuously usable logical channels are made available as a subset of individual carriers, by using OFDM methods.

6. The transmission system as claimed in claim 1, further comprising a data rate setting device configured to set the available data rate of the individual logical channels according to current demand.

7. The transmission system as claimed in claim 1, further comprising an error correction device configured to carry out a forward error protection method to reduce transmission errors.

8. An automation installation for the automation of a technical process, comprising:
a control device configured to control a performance of the technical process by at least one drive device, and
a transmission system for the wireless transmission of signals between a plurality of elements of the automation installation that includes a plurality of network nodes to which one element of the plurality of elements of the automation installation is in each case connected, wherein a separate, continuously usable logical channel, via which signals are configured to be transmitted wirelessly, is allocated to each network node.

9. A transmission method for the wireless transmission of signals between a plurality of elements of an automation installation, comprising:
wirelessly transmitting signals by a plurality of network nodes to which one element of the plurality of elements of the automation installation is in each case connected,
wherein a separate, continuously usable logical channel, via which signals are configured to be transmitted wirelessly, is allocated to each network node.
